(19) United States
(12) Patent Application Publication
(10) Pub. No.: US 2026/0363820 A1
(43) Pub. Date: Nov. 19, 2026

(54) CROWN HOLDER

(71) Applicant: Dentatus USA, Ltd., Hawthorne, NY (US)

(72) Inventors: Tomoyuki Okamoto, Hawthorne, NY (US); Peter Hedstrom, Spånga (SE)

(73) Assignee: Dentatus USA, Ltd., Hawthorne, NY (US)

(21) Appl. No.: 19/575,692

(22) Filed: Mar. 23, 2026

Related U.S. Application Data
(60) Provisional application No. 63/775,839, filed on Mar. 21, 2025.

(51) Int. Cl. A61C 3/16

(52) U.S. Cl. CPC A61C 3/162

(57) ABSTRACT

A crown holder is used for gripping, holding, positioning, and manipulating a dental crown. The crown holder includes a holder, first and second arms having distal tip ends, first and second arm seats, a first pin defining a pivot axis for the arm seats, a second pin disposed in slots of the arm seats, and a drive system having a central rod, a control wheel, and a traveling adjuster. Rotation of the control wheel causes movement of the traveling adjuster, movement of the second pin within the slots, pivoting of the arm seats about the first pin, and movement of the distal tip ends between open and closed positions for selectively engaging a dental crown. The crown holder engages the crown from the inside or the outside and includes removable arm structures, splayed arms, friction-enhancing tip surfaces, and looped outside tips.

### CROSS REFERENCE TO RELATED APPLICATIONS

This application claims the benefit of and priority to U.S. Provisional Patent Application No. 63/775,839, which is pending, and which was filed Mar. 21, 2025, and entitled “CROWN HOLDER,” the entire disclosure of which is hereby incorporated by reference herein in its entirety for all purposes to the extent permitted by law.

### BACKGROUND OF THE INVENTION

### Field of the Invention

### Field of the Invention

The present invention relates generally to dental instruments and, more particularly, to crown holders for gripping, holding, positioning, and manipulating dental crowns and similar dental restorations. More particularly, the invention relates to crown holders having crown-engaging members configured to selectively engage a dental crown from inside the dental crown or from outside the dental crown, including embodiments having an actuation arrangement for controlling movement of the crown-engaging members. Please provide a summary of the invention. This is usually separate from the Abstract section found later in the document.

### Description of the Related Art

### Description of the Related Art

Dental crowns are manipulated during fabrication, inspection, fitting, adjustment, placement, cementation, and other clinical or laboratory procedures. Because a dental crown is relatively small and may have smooth or contoured surfaces, it can be difficult to grip and manipulate the crown securely while maintaining visibility, access, and precise control.

In some situations, it is desirable to hold a crown from the inside of the dental crown. In other situations, it is desirable to hold the crown from the outside of the dental crown, for example during placement of the crown. It may also be desirable to provide different crown-engaging configurations for different procedures, including inside-gripping configurations, outside-gripping configurations, and outside-tip configurations such as looped outside tips.

Conventional instruments may not always provide the desired combination of secure crown retention, controlled manipulation, ease of operation, interchangeable gripping structures, and reliable actuation of crown-engaging members. In particular, there remains a need for improved mechanisms for moving crown-engaging members between open and closed positions in a smooth, controlled, and repeatable manner.

Accordingly, there remains a need for improved crown holders that can selectively engage a dental crown from the inside or from the outside, that can provide secure retention and controlled manipulation of the crown, and that can be configured with different crown-engaging structures for different uses. There also remains a need for improved actuation mechanisms for controlling movement of crown-engaging members, including mechanisms employing grip seats, pins, guides, and wheel-driven screw arrangements.

The present disclosure addresses these and other needs by providing, in various embodiments, crown holders having selectively movable crown-engaging members and, in certain embodiments, an updated mechanical interface in which movement of grip seats is controlled through a wheel, a screw, one or more pins, and one or more guides.

### BRIEF SUMMARY OF THE INVENTION

### Brief Summary of the Invention

In accordance with some embodiments of the present invention, a crown holder is provided for gripping, holding, positioning, and manipulating a dental crown. The crown holder selectively engages the crown from the inside or from the outside and is provided in different crown-engaging configurations for different clinical or laboratory uses, including inside-gripping configurations, outside-gripping configurations, and outside-tip configurations such as looped outside tips.

In some embodiments, a first crown holder includes a holder, a pair of arms, a drive system, a control wheel, and a housing assembly. The arms are movable relative to one another between positions for engaging a dental crown and are configurable for inside engagement, outside engagement, or both. The arms can include tip ends having friction-enhancing surfaces, such as diamond-coated surfaces, to improve grip of the dental crown.

In some embodiments of the first crown holder, removable or interchangeable arm structures are provided. The holder includes arm seats, wells, boots, pins, ramps, and related structures configured to permit mounting, removal, replacement, and controlled movement of crown-engaging arms. A drive system including a central rod, a control wheel, and a traveling adjuster moves the arms between open and closed positions.

In another embodiment, a second crown holder is provided. In some embodiments, the second crown holder retains a generally similar arm-to-holder mounting arrangement while using a different actuation arrangement for opening and closing the arms.

In some embodiments, the second crown holder includes a holder having a pair of arms, arm seats, pins, a drive system, a control wheel, a traveling adjuster, a wheel stop, and a housing assembly. The housing assembly includes lower and upper housing units, a cover, and guides. In some embodiments, the arms move relative to one another in response to rotation of the control wheel.

In some embodiments of the second crown holder, the arms are removably received in the arm seats. The arms include extensions received in wells of the arm seats in a friction fit, and additional retention is provided by engagement plates and retaining arm pairs configured to engage tabs formed on the arm seats. The arms can be generally straight or splayed apart along at least a portion of their length for improved access, visibility, and handling.

In some embodiments, lower portions of the arm seats include through-openings receiving a first pin and slots receiving a second pin. The first pin defines a rotation point for the arm seats, and movement of the second pin within the slots causes controlled pivoting of the arm seats about the first pin, thereby moving the arms between open and closed positions.

In some embodiments, the drive system includes a central rod, a travel thread, a control wheel, a traveling adjuster, guides, and a wheel stop. The control wheel remains in a fixed axial position relative to the housing while being rotatable relative thereto. Rotation of the control wheel causes corresponding threaded movement within the drive system, thereby moving the traveling adjuster toward a distal end or toward a proximal end, depending on rotation direction.

In some embodiments, the traveling adjuster is operatively associated with the second pin such that movement of the traveling adjuster causes movement of the second pin within the slots of the arm seats, thereby pivoting the arm seats about the first pin. The guides guide movement of the traveling adjuster and/or the central rod, and the wheel stop supports or aligns the guides during operation.

In some embodiments, the second crown holder uses the same general crown-engaging arrangements as the first crown holder, including inside-gripping arrangements, outside-gripping arrangements, and outside-tip arrangements such as looped outside tips. Components of one embodiment can also be used with the other embodiment where appropriate.

In some embodiments, the present invention provides crown holders capable of selectively engaging a dental crown from the inside or from the outside, providing secure retention and controlled manipulation of the dental crown, and providing mechanical arrangements for moving crown-engaging arms in a controlled and repeatable manner.

In some embodiments, the invention comprises a crown holder including a holder, first and second arms supported by the holder, and first and second arm seats associated with the first and second arms, respectively. Each of the first and second arms has a distal tip end configured to engage a dental crown. The first and second arm seats are pivotable about a first pin defining a pivot axis, and a second pin is disposed in slots of the first and second arm seats.

In some embodiments, the crown holder further comprises a drive system including a central rod, a control wheel, and a traveling adjuster. Rotation of the control wheel causes movement of the traveling adjuster relative to the central rod, movement of the second pin within the slots of the first and second arm seats, pivoting of the first and second arm seats about the first pin, and corresponding movement of the distal tip ends of the first and second arms between the open position and the closed position.

In some embodiments, the control wheel is supported in a fixed axial position relative to a housing of the crown holder while being rotatable relative thereto. The central rod includes a travel thread and the control wheel includes an internal thread cooperating with the travel thread. The first and second arm seats include lower portions having through-openings receiving the first pin and angled slots receiving the second pin, the second pin being parallel to the first pin.

In some embodiments, the traveling adjuster includes a through passage receiving the second pin and a recess receiving lower portions of the first and second arm seats. The crown holder further includes first and second guides and a wheel stop, wherein the first and second guides guide movement of the traveling adjuster and the wheel stop supports or aligns the first and second guides.

In some embodiments, the first and second arms are removably mounted to the first and second arm seats by extensions of the first and second arms received in wells of the first and second arm seats in a friction fit. Additional retention of the first and second arms is provided by an engagement plate and retaining arm pairs configured to engage tabs formed on the first and second arm seats. The first and second arms can be splayed apart relative to each other along at least a portion of their length.

In some embodiments, the distal tip ends are configured for selectively engaging a dental crown from inside the dental crown or from outside the dental crown. The distal tip ends can comprise looped outside tips or friction-enhancing surfaces.

In additional embodiments, a method of using a crown holder is provided. In some embodiments, the method includes providing a crown holder having a holder, first and second arms, first and second arm seats, a first pin, a second pin, a central rod, a control wheel, and a traveling adjuster; rotating the control wheel to actuate a drive system of the crown holder; moving the traveling adjuster relative to the central rod in response to rotation of the control wheel; moving the second pin relative to slots of the first and second arm seats in response to movement of the traveling adjuster; pivoting the first and second arm seats about the first pin in response to movement of the second pin; and moving distal tip ends of the first and second arms relative to one another between an open position and a closed position to engage or release a dental crown.

In some embodiments, rotating the control wheel in a first direction moves the traveling adjuster in a distal direction and moves the distal tip ends outwardly relative to one another. In some embodiments, rotating the control wheel in a second direction opposite the first direction moves the traveling adjuster in a proximal direction and moves the distal tip ends inwardly relative to one another. In some embodiments, the method further includes engaging the dental crown from inside the dental crown or from outside the dental crown, manipulating the crown holder after engagement to inspect, transport, orient, fit, or place the dental crown relative to a prepared tooth, and releasing the dental crown by rotating the control wheel to move the distal tip ends away from engagement with the dental crown.

In some embodiments, the method further includes removing one pair of arms and installing another pair of arms having a different crown-engaging configuration. In some embodiments, first and second guides guide movement of the traveling adjuster and a wheel stop supports or aligns the first and second guides during operation of the crown holder.

In some embodiments, the present invention provides crown holders and methods of using the same, capable of selectively engaging a dental crown, providing controlled movement of crown-engaging arms, and facilitating inspection, fitting, placement, and release of a dental crown.

This disclosure and the description of the invention is provided to assist in an understanding of various embodiments as defined by the claims and their equivalents. The embodiments are merely exemplary and various changes and modifications of the various embodiments may be made without departing from the scope and spirit of the invention. One or more embodiments may be combined with one or more other embodiments. Where one unit of an item is disclosed, more than one unit of that item may be used for at least the reason of economic efficiency. Conversely, where more than one unit of an item is disclosed, only one unit of that item may be used for at least the reason of economy, space-saving, manufacturing efficiency, and/or power consumption.

### BRIEF DESCRIPTION OF THE DRAWINGS

### Brief Description of the Drawings

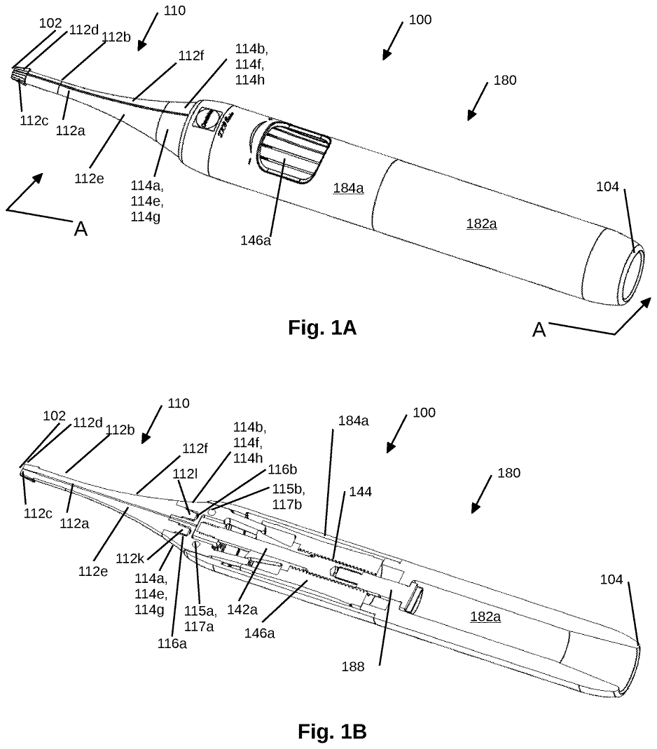

FIG. 1A is a perspective view of crown holder 100 in accordance with one or more embodiments of the present invention.

FIG. 1B is a cross-sectional view of crown holder 100 of FIG. 1A taken at plane A-A of FIG. 1A.

FIG. 1C is a perspective view of crown holder 100 of FIG. 1A with the lower housing unit and upper housing unit removed.

FIG. 1D is a cross-sectional view of crown holder 100 of FIG. 1C taken at plane B-B of FIG. 1C.

FIG. 1E is a cross-sectional view of crown holder 100 of FIG. 1C taken at plane B-B of FIG. 1C with one arm and one arm seat removed.

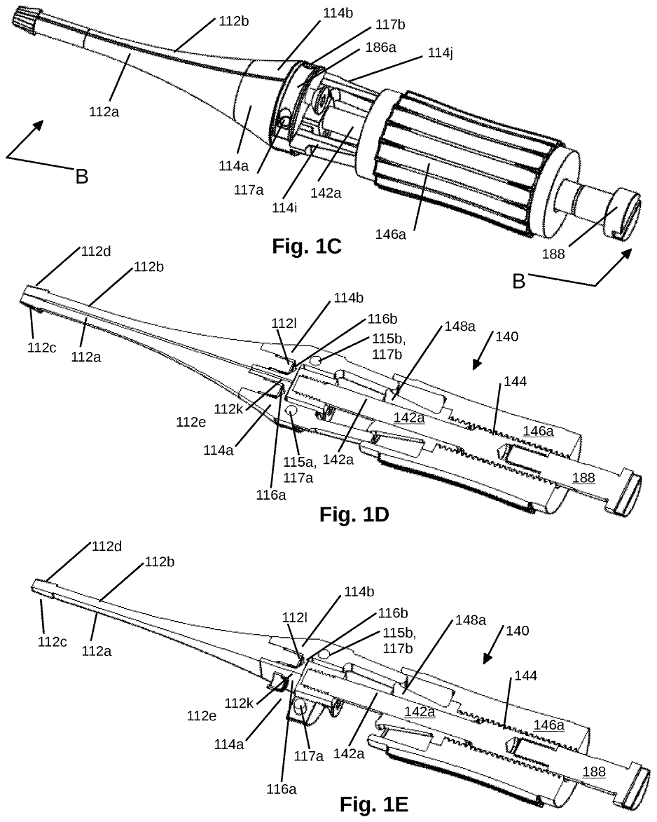

FIG. 2A is a perspective view of arm seats 114a, 114b.

FIG. 2B is a cross-sectional view of arm seats 114a, 114b of FIG. 2A taken at plane A-A of FIG. 2A.

FIG. 2C is a top view of arm seats 114a, 114b of FIG. 2A.

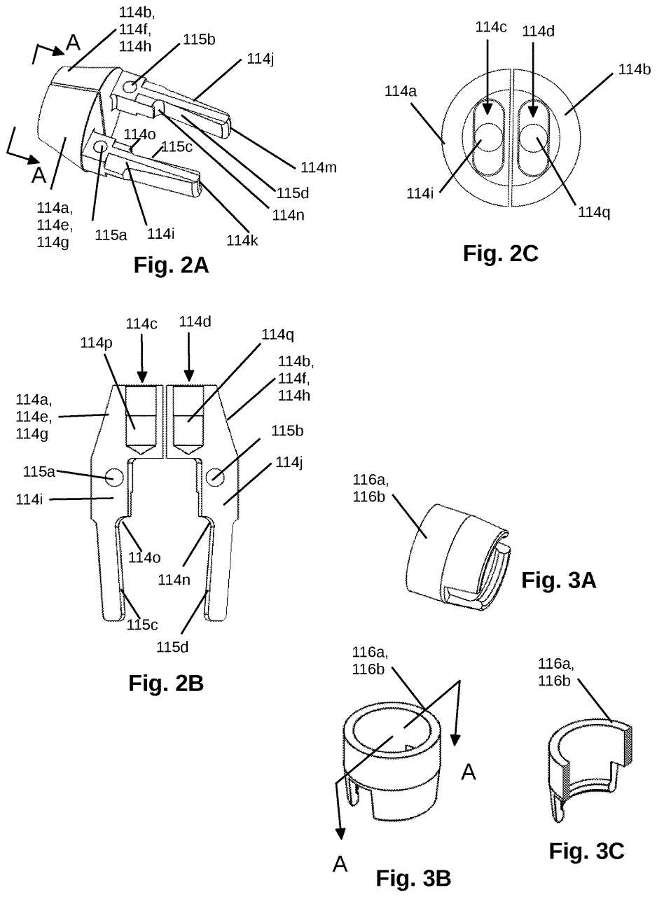

FIG. 3A is a bottom perspective view of a boot 116a.

FIG. 3B is a side perspective view of boot 116a.

FIG. 3C is a cross-sectional view of boot 116a of FIG. 3B taken at plane A-A of FIG. 3B.

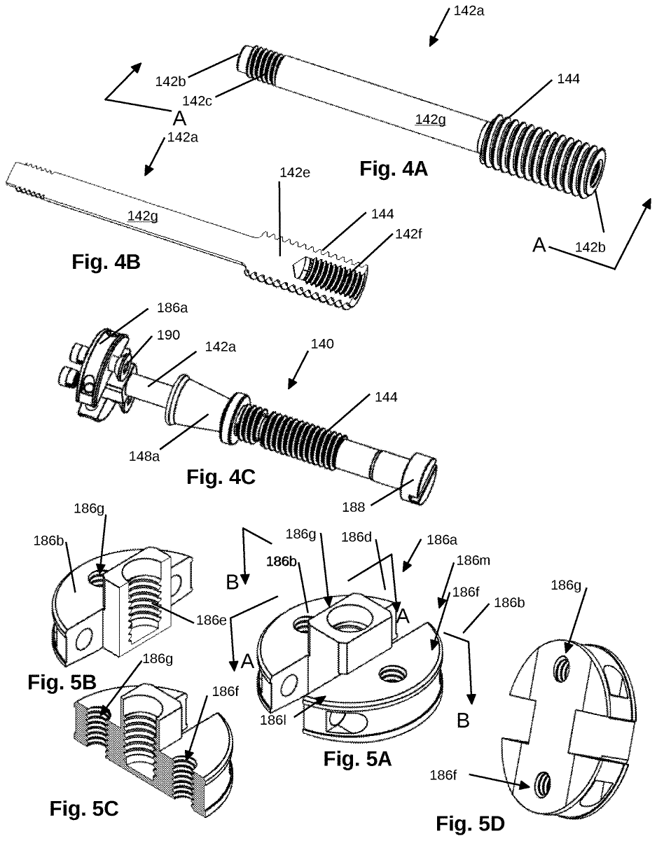

FIG. 4A is a perspective view of central rod 142a.

FIG. 4B is a cross-sectional view of central rod 142a of FIG. 4A taken at plane A-A of FIG. 4A.

FIG. 4C is a perspective view of central rod 142a of FIG. 4A as part of the drive assembly and joined to securing bolt 188, traveling adjuster 148a, and lid 186a.

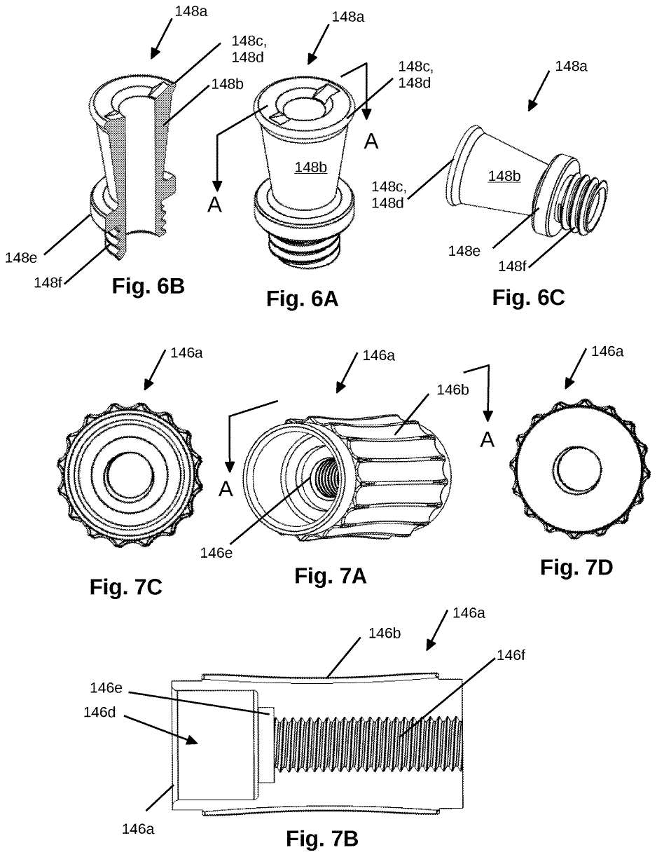

FIG. 5A is a perspective view of lid 186a.

FIG. 5B is a cross-sectional view of lid 186a of FIG. 5A taken at plane A-A of FIG. 5A.

FIG. 5C is a cross-sectional view of lid 186a of FIG. 5A taken at plane B-B of FIG. 5A.

FIG. 5D is a bottom perspective view of lid 186a of FIG. 5A.

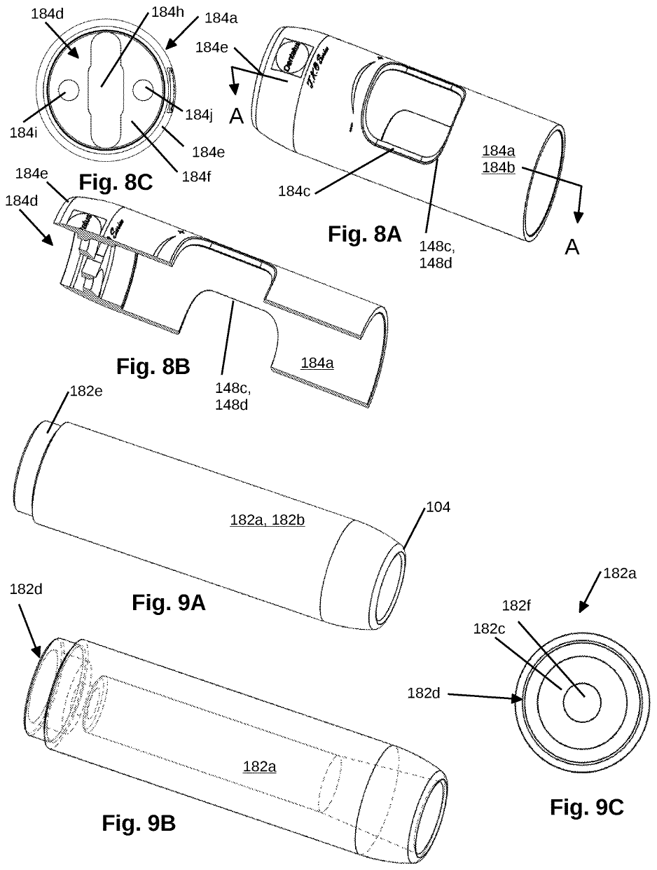

FIG. 6A is a first perspective view of traveling adjuster 148a.

FIG. 6B is a cross-sectional view of traveling adjuster 148a of FIG. 6A taken at plane A-A of FIG. 6A.

FIG. 6C is a second perspective view of traveling adjuster 148a of FIG. 6A.

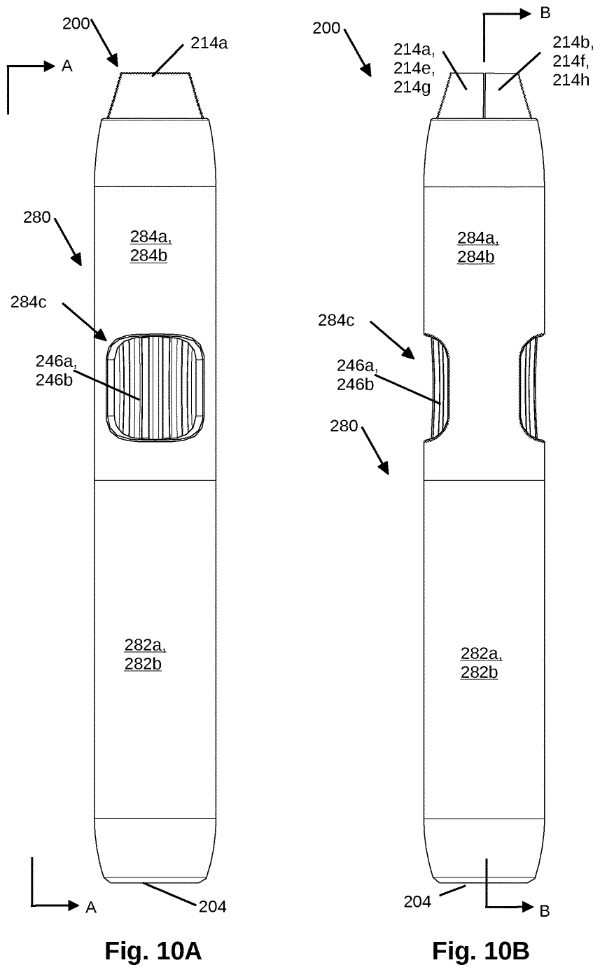

FIG. 7A is a perspective view of control wheel 146a.

FIG. 7B is a cross-sectional view of control wheel 146a of FIG. 7A taken at plane A-A of FIG. 7A.

FIG. 7C is a distal end view of control wheel 146a of FIG. 7A.

FIG. 7D is a proximal end view of control wheel 146a of FIG. 7A.

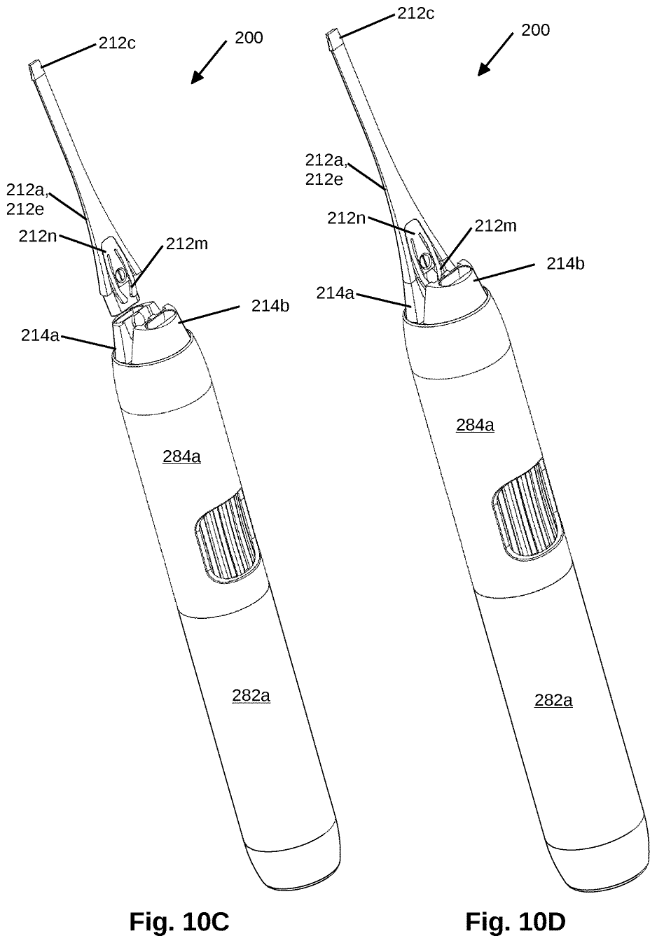

FIG. 8A is a perspective view of upper housing unit 184a.

FIG. 8B is a cross-sectional view of upper housing unit 184a of FIG. 8A taken at plane A-A of FIG. 8A.

FIG. 8C is a distal end view of upper housing unit 184a of FIG. 8A.

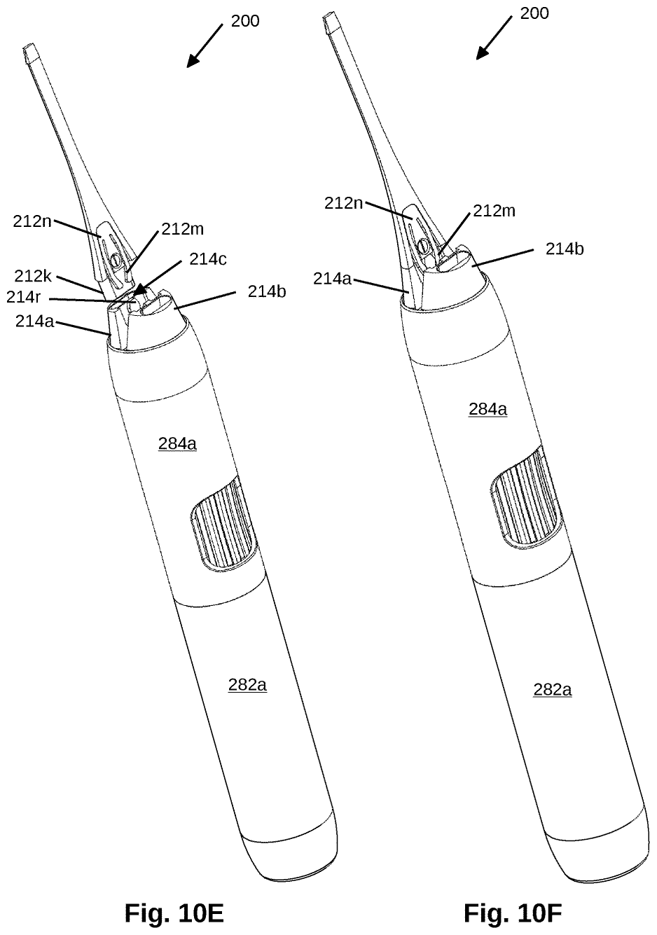

FIG. 9A is a perspective view of lower housing unit 182a.

FIG. 9B is a perspective view of lower housing unit 182a of FIG. 9A showing hidden lines.

FIG. 9C is a distal end view of lower housing unit 182a of FIG. 9A.

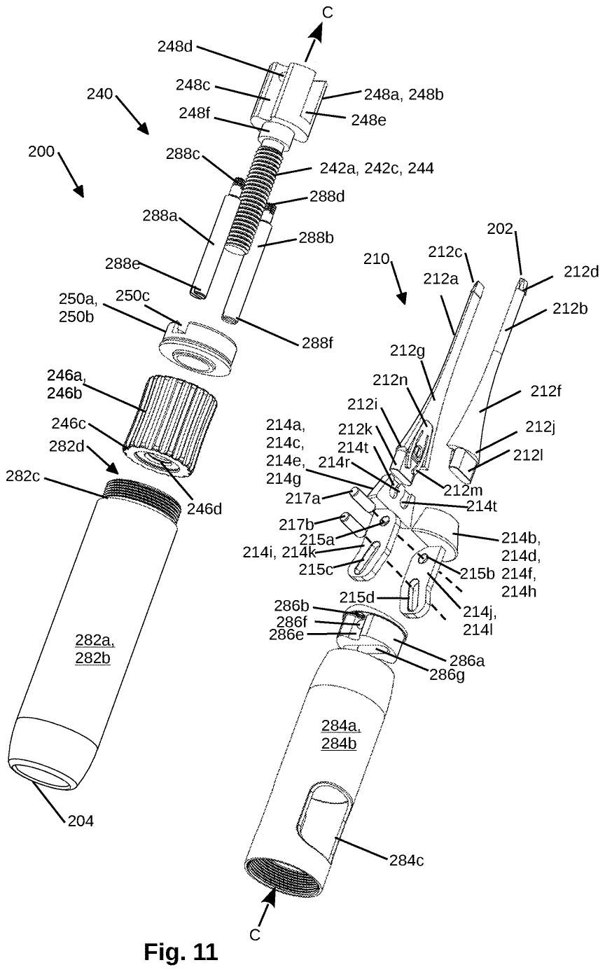

FIG. 10A is a front elevational view of crown holder 200 in a closed position.

FIG. 10B is a side elevational view of crown holder 200 in the closed position.

FIG. 10C is a perspective view of crown holder 200 showing a removable-arm retention arrangement including an engagement plate and retaining arm pairs.

FIG. 10D is another perspective view of crown holder 200 showing the removable-arm retention arrangement of FIG. 10C.

FIG. 10E is another perspective view of crown holder 200 showing the removable-arm retention arrangement with an arm extension, a well, and a tab visible.

FIG. 10F is another perspective view of crown holder 200 showing the removable-arm retention arrangement of FIG. 10E from a different angle.

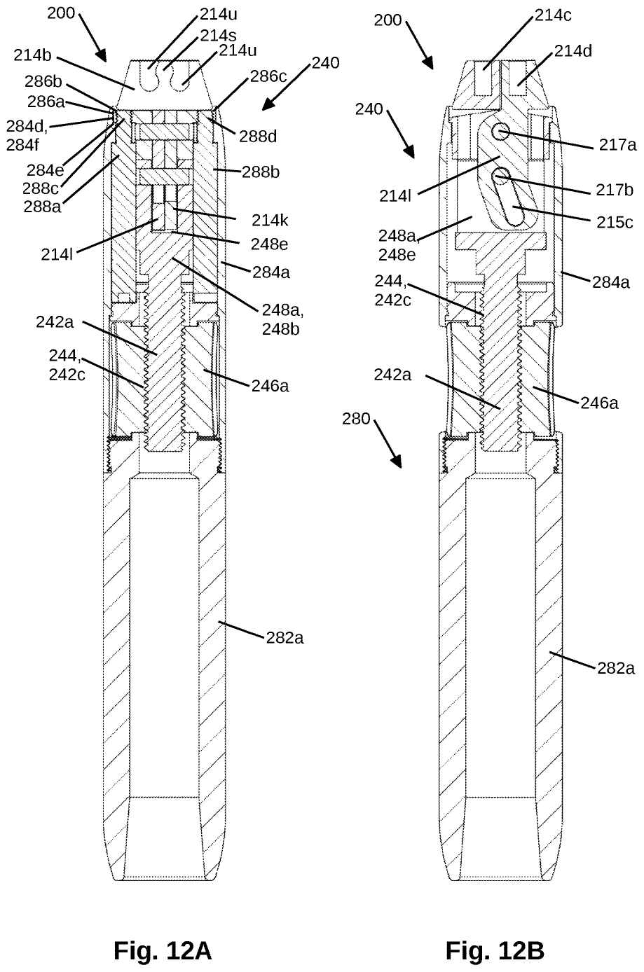

FIG. 11 is an exploded perspective view of crown holder 200.

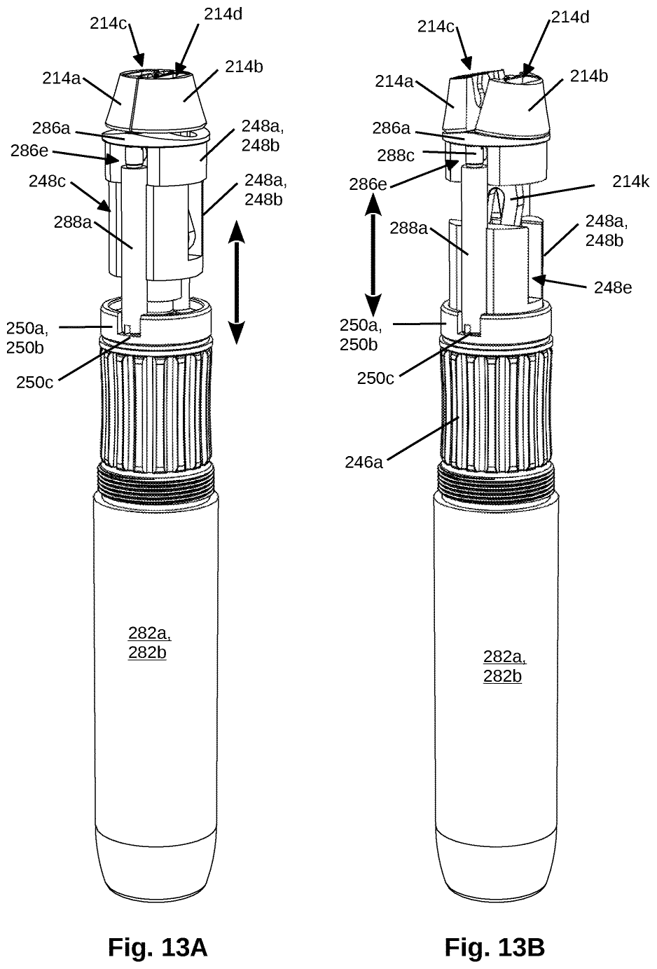

FIG. 12A is a cross-sectional view taken at plane A-A of FIG. 10A showing the updated drive system of crown holder 200.

FIG. 12B is a cross-sectional view taken at plane B-B of FIG. 10B showing the updated drive system of crown holder 200.

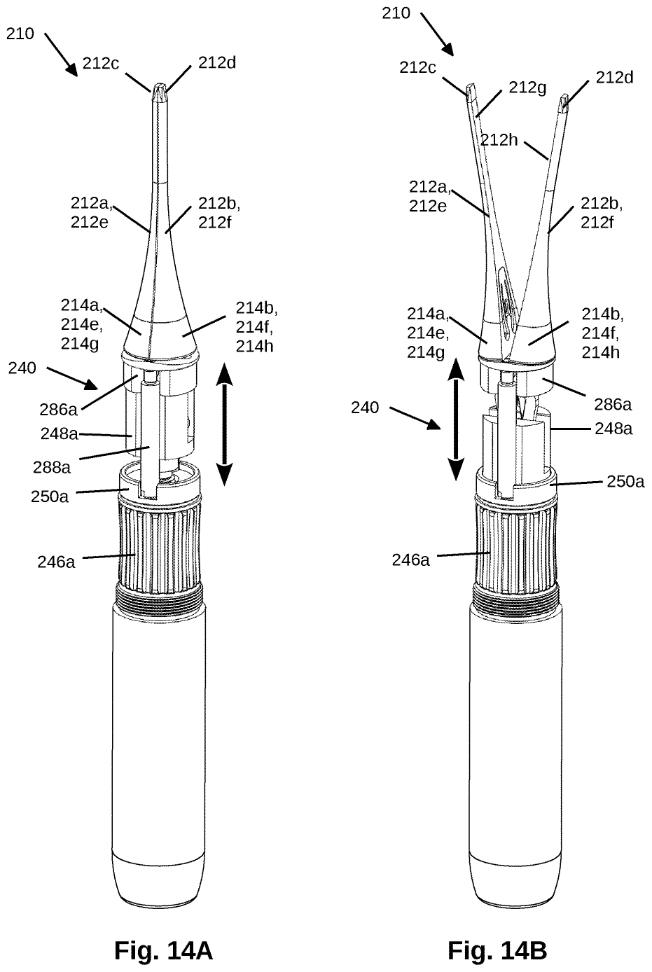

FIG. 13A is a view of a first arm and tip configuration of crown holder 200 in a closed position, wherein the upper housing unit has been removed for clarity of illustration.

FIG. 13B is a view of the first arm and tip configuration of crown holder 200 in an open position, wherein the upper housing unit has been removed for clarity of illustration.

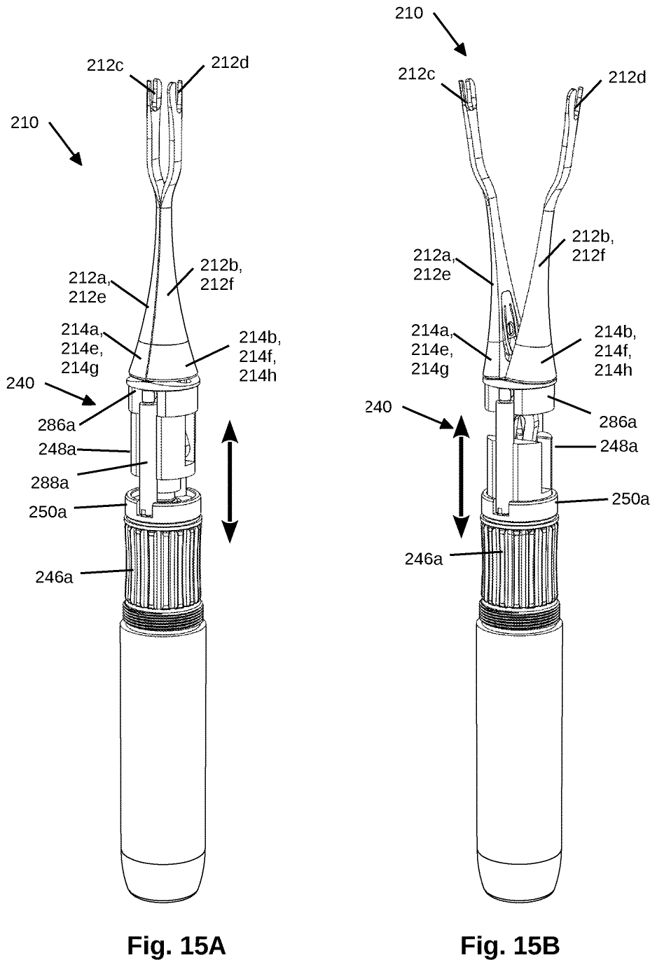

FIG. 14A is a view of a second arm and tip configuration of crown holder 200 in a closed position, wherein the upper housing unit has been removed for clarity of illustration.

FIG. 14B is a view of the second arm and tip configuration of crown holder 200 in an open position, wherein the upper housing unit has been removed for clarity of illustration.

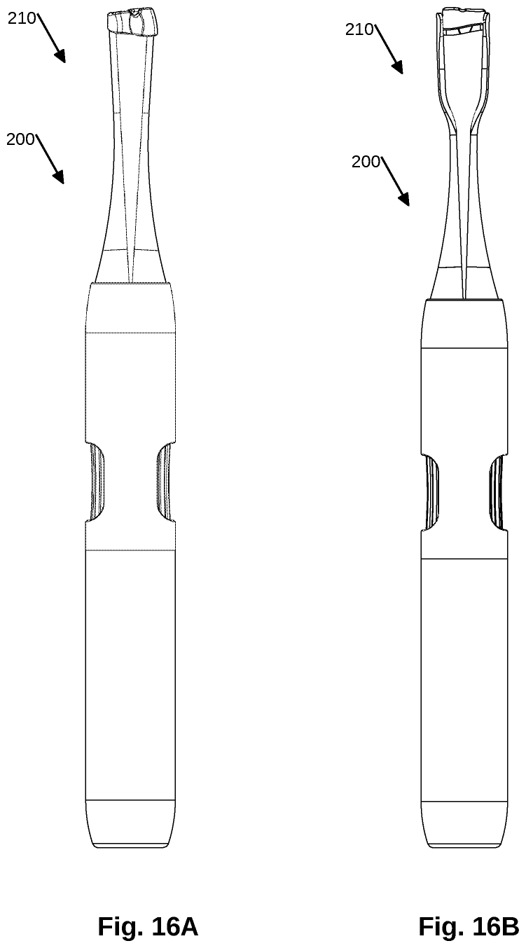

FIG. 15A is a view of a third arm and tip configuration of crown holder 200 in a closed position, wherein the upper housing unit has been removed for clarity of illustration.

FIG. 15B is a view of the third arm and tip configuration of crown holder 200 in an open position, wherein the upper housing unit has been removed for clarity of illustration.

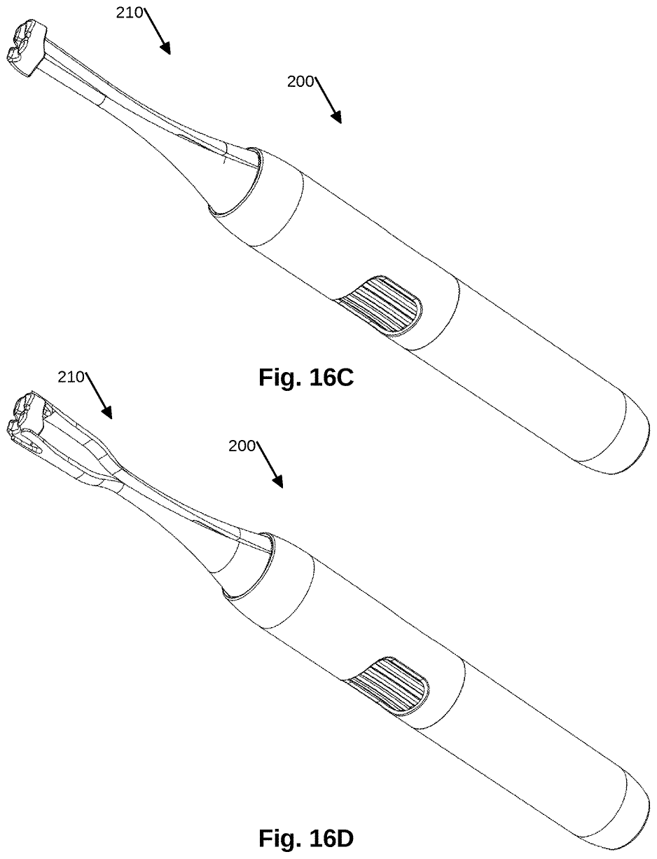

FIG. 16A is a view of crown holder 200 holding a crown from the inside.

FIG. 16B is a partially sectioned view of crown holder 200 holding a crown from the inside, wherein the crown holder includes a forked arm tip and outside facets on the grips are diamond coated to grip the crown firmly on the inside.

FIG. 16C is a view of crown holder 200 having outside tips configured as looped outside tips for outside engagement of a crown.

FIG. 16D is a view of crown holder 200 having outside tips configured as forked outside tips for outside engagement of a crown.

### DETAILED DESCRIPTION OF INVENTION

### Detailed Description of the Invention

### 1. General Overview

In accordance with some embodiments of the present invention, a crown holder is used by a user to manipulate a dental crown from the inside or outside of the dental crown. The user is typically a person trained in handling dental appliances, such as a dentist or dental technician.

In some embodiments, the invention includes a first crown holder embodiment identified as crown holder 100 and a second crown holder embodiment identified as crown holder 200. Crown holder 100 and crown holder 200 differ in the mechanical design, i.e., the drive system, for opening and closing the arms. In some embodiments, components of crown holder 100 can be used with crown holder 200, and components of crown holder 200 can be used with crown holder 100, where appropriate, including arm structures, arm-mounting structures, inner-gripping structures, outer-gripping structures, and tip configurations such as outside tips or looped outside tips.

For ease of explanation, “distal” herein refers to a position closer to a distal end than a proximal end of the crown holder, and “proximal” herein refers to a position closer to a proximal end than a distal end. In the illustrated embodiments, the distal end is at the crown-engaging end of the instrument and the proximal end is at the hand-held end.

### 2. First Embodiment: Crown Holder 100

In accordance with some embodiments of the present invention, crown holder 100 comprises a plurality of components including a holder 110 comprising a pair of arms 112a, 112b, a drive system 140, a control wheel 146a, and a housing assembly 180. The arms are manipulated to be spaced apart relative to a closed position or closer together relative to a non-closed position by drive system 140 engaged by the user via control wheel 146a, while housing assembly 180 provides structural integrity and an ergonomic shape for safe handling of crown holder 100 by the user.

Holder 110 comprises arm 112a and arm 112b. Each arm comprises a tip end 112c, 112d, respectively, defining distal end 102, and a tapered curved outer surface 112e, 112f, respectively, for ease of use, storage, cleaning, and/or safety. Each arm further comprises a planar surface 112g, 112h, respectively, positioned opposite the planar surface of the other arm. Tip ends 112c, 112d are diamond coated to ensure suitable frictional grip of a dental crown. In a closed position, planar surfaces 112g, 112h are substantially parallel to each other and tip ends 112c, 112d are proximate to each other. In an open position, planar surfaces 112g, 112h are not substantially parallel to each other and tip ends 112c, 112d are spaced apart to act on an object such as a dental crown by exerting force on the inside walls of the dental crown or on the outside of the dental crown.

Abutments 112i, 112j are proximal to arm seats 114a, 114b, respectively. To permit convenient removal and insertion of arms 112a, 112b, extensions 112k, 112l are provided on the arms and friction fit in wells 114c, 114d of arm seats 114a, 114b via boots 116a, 116b. Each arm seat 114a, 114b comprises an upper portion 114e, 114f, respectively, having a body shape continuing the taper of the respective arm and a curved surface 114g, 114h continuing the curved surface of the respective arm. Lower portions 114i, 114j are stub-shaped and each has a through-opening 115a, 115b for receiving a pin 117a, 117b and a ramp 115c, 115d extending from a proximal end 114k, 114m to a stop 114n, 114o. Arm seats 114a, 114b are pivotally displaced about pins 117a, 117b by an adjuster 148a that moves from proximal ends 114k, 114m toward stops 114n, 114o.

Drive system 140 comprises a central rod 142a having a travel thread 144 on which control wheel 146a is movably mounted to force a traveling adjuster 148a in the direction to or from distal end 102 to act on ramps 115c, 115d. Central rod 142a is a straight rod of solid material and has a distal end 142b proximal to which is an outer thread 142c for engaging an inner thread in lid 186a to secure distal end 142b to housing assembly 180. At a proximal end, a widened portion 142e comprises travel thread 144 on the outside of central rod 142a and inner thread 142f for engaging securing bolt 188. A straight and unthreaded portion 142g is defined between outer thread 142c and widened portion 142e.

Control wheel 146a comprises a substantially cylindrical body having an outer surface 146b. Outer surface 146b is concave from the distal end toward a proximal end to permit the user to rotate the control wheel using thumb and finger. The outer surface may be textured, for example by fluting, although other texturing such as knurling may be used. Traveling adjuster 148a comprises a substantially conical portion 148b having at a distal end a bearing ring 148c with a bearing surface 148d.

A disk portion 148e is disposed between conical portion 148b and threaded end portion 148f. The distal end of control wheel 146a comprises an opening 146d wherein disk portion 148e is disposed against floor 146e, and threaded end portion 148f is secured to control wheel 146a via a distal portion of internal thread 146f. When control wheel 146a moves traveling adjuster 148a toward distal end 102, arm seats 114a, 114b are displaced as bearing surface 148d bears against ramps 115c, 115d. In some embodiments, threaded end portion 148f and travel thread 144 comprise the same thread diameter and thread pitch so that the internal thread of the control wheel cooperates with both.

Housing assembly 180 comprises lower housing unit 182a, upper housing unit 184a, lid 186a, securing bolt 188, and screws 190. Lower housing unit 182a comprises a generally tubular body 182b having an open proximal end defining proximal end 104. A wall 182c is recessed from distal open end 182d and is defined by a stepped-back mating ring 182e. An opening 182f permits the shaft of securing bolt 188 to pass through the wall.

Upper housing unit 184a comprises a substantially tubular body 184b having one or more windows 184c, shown as two windows for use of control wheel 146a by thumb and forefinger. A recess 184d is defined by upper edge 184e and wall 184f. Lid 186a is disposed in recess 184d and comprises disk segment portions 186b and a block 186d spacing the disk segment portions apart. Block 186d passes through central opening portion 184h of wall 184f and comprises an inner thread 186e for receiving outer thread 142c of central rod 142a. Each disk segment portion 186b comprises an opening 186f, 186g aligned with openings 184i, 184j in wall 184f, so that a fastener, such as screw 190, secures upper housing unit 184a and lid 186a to each other. Each disk segment portion also comprises openings for receiving pins 117a, 117b, the pins passing through through-openings 115a, 115b of lower portions 114i, 114j to retain the arm seats while permitting pivoting.

### 3. Second Embodiment: Crown Holder 200

In additional embodiments, the invention comprises a second crown holder identified as crown holder 200.

Crown holder 200 can retain the general arm-to-holder mounting arrangement of the first embodiment, and inner-gripping and outer-gripping arm versions can also remain the same as in the first embodiment, but the mechanical design, including the drive system for opening and closing the arms, is different.

In some embodiments, any component of crown holder 100 may be used with crown holder 200, and any component of crown holder 200 may be used with crown holder 100, where suitable, including, for example, arm structures, arm-mounting structures, inner-gripping structures, outer-gripping structures, and tip configurations such as outside tips or looped outside tips.

In the second embodiment, crown holder 200 comprises a plurality of components including a holder 210 comprising a pair of arms 212a, 212b, arm seats 214a, 214b, pins 217a, 217b, a drive system 240, a control wheel 246a, a traveling adjuster 248a, a wheel stop 250a, and a housing assembly 280. The drive system, actuated by the user via control wheel 246a, moves the arms between an open position in which the arms are spaced apart and a closed position in which the arms are closer together, while housing assembly 280 provides structural integrity and an ergonomic shape for safe handling of crown holder 200 by the user.

For ease of explanation, distal end 202 is at the crown-engaging end of crown holder 200, and proximal end 204 is at the hand-held end of crown holder 200.

Holder 210 comprises arm 212a and arm 212b. Each arm comprises a respective tip end 212c, 212d defining distal end 202, and a respective tapered curved outer surface 212e, 212f for ease of use, storage, cleaning, and/or safety. Each arm may further comprise a respective planar surface 212g, 212h positioned opposite the planar surface of the other arm. In some embodiments, the arms may be generally straight. In other embodiments, the arms may be splayed apart relative to each other along at least a portion of their length for improved access, dexterity, visibility, comfort, and/or handling by the user, as shown, for example, in FIGS. 13A-16D.

Tip ends 212c, 212d may be configured for selectively engaging a dental crown from the inside of the crown or from the outside of the crown. In some embodiments, tip ends 212c, 212d or portions thereof may be diamond coated or otherwise provided with friction-enhancing surfaces to improve gripping performance. In some embodiments, crown holder 200 may be used with inside-gripping arrangements, outside-gripping arrangements, and outside-tip arrangements such as looped outside tips, as illustrated for example by the alternative arm and tip configurations of FIGS. 14A-16B.

Abutments 212i, 212j of the arms are proximal to arm seats 214a, 214b, respectively. To permit convenient removal and insertion of arms 212a, 212b, extensions 212k, 212l are provided on the arms and fit in wells 214c, 214d of arm seats 214a, 214b. Each arm seat 214a, 214b comprises a respective upper portion 214e, 214f having a body shape continuing the taper of the respective arm and a respective curved surface 214g, 214h continuing the curved surface of the respective arm. Wells 214c, 214d are disposed in upper portions 214e, 214f, respectively, and each well comprises a void configured to receive all or a portion of the respective extension 212k, 212l. In some embodiments, the fit between extensions 212k, 212l and wells 214c, 214d is a friction fit for secure retention of the respective arm.

In some embodiments, additional retention is provided by engagement plates 212n. Engagement plates 212n are secured, for example by a fastener such as a screw, in recesses formed in respective planar surfaces 212g, 212h at proximal portions of the arms. In some embodiments, engagement plates 212n comprise retaining arm pairs 212m configured to fit over respective tabs 214r, 214s formed on arm seats 214a, 214b, for example by respective recesses 214t, 214u. In this manner, engagement plates 212n engage respective tabs 214r, 214s and help prevent dislocation of respective arms 212a, 212b from holder 210. FIGS. 10C-10F illustrate example views of the removable-arm retention arrangement, including engagement plate 212n and retaining arm pairs 212m associated with arm seats 214a, 214b.

In some embodiments, FIG. 10E shows the removable-arm retention arrangement with one or more of extension 212k, well 214c, and tab 214r visible relative to engagement plate 212n and retaining arm pairs 212m, and FIG. 10F shows another perspective of the same arrangement. These figures further illustrate how the arm-retention components cooperate to secure the removable arms relative to holder 210 while permitting selective substitution of different arm and tip configurations.

Arm seats 214a, 214b further comprise respective lower portions 214i, 214j. In some embodiments, lower portions 214i, 214j are plate-like structures having lower segments 214k, 214l angled relative to a central axis extending between distal end 202 and proximal end 204 of crown holder 200. Each lower portion 214i, 214j has a through-opening 215a, 215b for receiving pin 217a, thereby creating a rotation point for the respective arm seat. Arm seats 214a, 214b are pivotally displaced about pin 217a. Slots 215c, 215d are formed in lower portions 214i, 214j as angled slots in lower segments 214k, 214l. Pin 217b is parallel to pin 217a and is disposed in slots 215c, 215d. As described further below, movement of pin 217b within slots 215c, 215d causes controlled pivoting of arm seats 214a, 214b about pin 217a, thereby moving arms 212a, 212b.

Housing assembly 280 comprises lower housing unit 282a, upper housing unit 284a, cover 286a, and guides 288a, 288b. Lower housing unit 282a comprises a generally tubular body 282b having an open proximal end defining proximal end 204. A wall 282c is recessed from distal open end 282d, and an opening may be provided through wall 282c. A mating ring may be provided at the distal end of lower housing unit 282a.

Upper housing unit 284a comprises a substantially tubular body 284b having one or more windows 284c, shown as two windows for manipulation of control wheel 246a by a thumb and forefinger. A recess 284d is defined by upper edge 284e and circumferential wall 284f. Cover 286a is disposed in recess 284d. In some embodiments, cover 286a is generally disk-shaped and comprises threaded openings 286b, 286c configured to receive threaded heads 288c, 288d of respective guides 288a, 288b. Recesses 286e may be provided on each side of cover 286a to receive respective guides 288a, 288b. A through hole 286f extends laterally through cover 286a and receives pin 217a. A passage 286g extends generally perpendicular to through hole 286f and receives lower portions 214i, 214j of arm seats 214a, 214b. By passing pin 217a through through hole 286f and through through-openings 215a, 215b of lower portions 214i, 214j, arm seats 214a, 214b are rotatably retained relative to cover 286a.

Drive system 240 is configured to move pin 217b and thereby actuate arm seats 214a, 214b. In some embodiments, drive system 240 comprises a central rod 242a, a travel thread 244, control wheel 246a, traveling adjuster 248a, guides 288a, 288b, and wheel stop 250a.

Central rod 242a is an elongate member extending generally between distal end 202 and proximal end 204 of crown holder 200. In some embodiments, central rod 242a includes an outer threaded portion 242c and travel thread 244. Control wheel 246a comprises a substantially cylindrical body having outer surface 246b, distal end 246c, and an internal thread 246d. Outer surface 246b is shaped for rotation by the user and may be concave, fluted, knurled, or otherwise textured. In use, control wheel 246a remains in a fixed axial position relative to upper housing unit 284a while being rotatable relative thereto.

Traveling adjuster 248a is operatively coupled to central rod 242a and control wheel 246a. In some embodiments, traveling adjuster 248a comprises a body 248b having outer recesses 248c for receiving portions of guides 288a, 288b, a through passage 248d for receiving pin 217b, and an inner slot or recess 248e for receiving lower portions 214i, 214j of arm seats 214a, 214b. Traveling adjuster 248a may further comprise a lower portion 248f coupled to central rod 242a or formed integrally therewith. By passing pin 217b through through passage 248d and through slots 215c, 215d when lower portions 214i, 214j are disposed in recess 248e, traveling adjuster 248a is able to move arm seats 214a, 214b and thereby splay or close arms 212a, 212b.

Wheel stop 250a is disposed relative to control wheel 246a and comprises an upstanding portion 250b having recesses 250c. End portions 288e, 288f of respective guides 288a, 288b are received in recesses 250c. Guides 288a, 288b thereby guide movement of traveling adjuster 248a and/or central rod 242a, and wheel stop 250a helps maintain the guides in a desired orientation, a generally parallel orientation.

In operation, rotation of control wheel 246a causes corresponding threaded movement within drive system 240, thereby moving traveling adjuster 248a and central rod 242a in a direction toward distal end 202 or toward proximal end 204, depending on rotation direction. In some embodiments, clockwise rotation of control wheel 246a causes central rod 242a and traveling adjuster 248a to move downwardly toward distal end 202. As traveling adjuster 248a moves, pin 217b moves within slots 215c, 215d of lower portions 214i, 214j, thereby causing arm seats 214a, 214b to pivot about pin 217a. This movement causes distal tip ends 212c, 212d of arms 212a, 212b to move outwardly or inwardly, depending on the direction of actuation. In this manner, crown holder 200 moves between closed and open positions, as illustrated, for example, in FIGS. 13A-15B.

Accordingly, in the second embodiment, the opening and closing function is achieved by slot-guided movement of arm seats 214a, 214b about pin 217a and by movement of pin 217b within slots 215c, 215d, rather than by the mechanical arrangement of the first embodiment. This actuation arrangement provides controlled movement of the arms while preserving compatibility with inner and outer arm versions and other crown-engaging arrangements of the first embodiment.

Because the arm-to-holder mounting arrangements remain the same as in other embodiments, and because the inner and outer arm versions also remain the same, crown holder 200 uses the same general crown-engagement arrangements described above for crown holder 100, including inside-gripping arrangements, outside-gripping arrangements, and outside-tip arrangements such as looped outside tips.

### 4. Method of Use of Crown Holder 200

In additional embodiments, a method of using crown holder 200 is provided. Crown holder 200 may be used by a dental practitioner, dental technician, or other trained user to grip, hold, position, manipulate, fit, inspect, place, remove, or otherwise handle a dental crown.

In some embodiments, the method comprises providing crown holder 200 having holder 210, arms 212a, 212b, arm seats 214a, 214b, drive system 240, control wheel 246a, traveling adjuster 248a, and housing assembly 280. The method further comprises rotating control wheel 246a to actuate drive system 240, thereby moving traveling adjuster 248a and causing movement of pin 217b relative to slots 215c, 215d of arm seats 214a, 214b. As pin 217b moves relative to slots 215c, 215d, arm seats 214a, 214b pivot about pin 217a, thereby moving arms 212a, 212b relative to one another between a more open position and a more closed position.

In some embodiments, a user rotates control wheel 246a in a first direction to move traveling adjuster 248a in a distal direction toward distal end 202. Such distal movement causes pin 217b to move within slots 215c, 215d, thereby pivoting arm seats 214a, 214b about pin 217a and moving distal tip ends 212c, 212d outwardly relative to one another. In some embodiments, the user rotates control wheel 246a in a second direction opposite the first direction to move traveling adjuster 248a in a proximal direction toward proximal end 204, thereby moving pin 217b in an opposite direction within slots 215c, 215d and moving distal tip ends 212c, 212d inwardly relative to one another. In this manner, crown holder 200 may be selectively adjusted between open and closed positions.

In some embodiments, the method comprises opening crown holder 200, positioning distal tip ends 212c, 212d relative to a dental crown, and actuating control wheel 246a to move arms 212a, 212b into engagement with the dental crown. In some embodiments, distal tip ends 212c, 212d engage the dental crown from the inside of the dental crown. In other embodiments, distal tip ends 212c, 212d engage the dental crown from the outside of the dental crown. In further embodiments, crown holder 200 is used with outside-tip arrangements, including looped outside tips, for engagement with an outer surface of the dental crown.

In some embodiments, after the dental crown has been engaged, the method comprises manipulating crown holder 200 to inspect, transport, orient, fit, or place the dental crown. In some embodiments, the method comprises using crown holder 200 to position the dental crown relative to a prepared tooth. In some embodiments, the method comprises using crown holder 200 to hold the dental crown during trial fitting, adjustment, finishing, or placement procedures.

In some embodiments, where arms 212a, 212b are removably mounted to arm seats 214a, 214b, the method further comprises removing one pair of arms and installing another pair of arms having a different crown-engaging configuration. In some embodiments, a user selects an inside-gripping arm configuration for engagement with an inner surface of a dental crown. In some embodiments, a user selects an outside-gripping arm configuration for engagement with an outer surface of a dental crown. In some embodiments, a user selects a looped outside-tip configuration for placement or manipulation of the dental crown. In this manner, crown holder 200 may be configured for different procedures and operator preferences.

In some embodiments, installing arms 212a, 212b comprises inserting extensions 212k, 212l into wells 214c, 214d of arm seats 214a, 214b. In some embodiments, engagement plate 212n and retaining arm pairs 212m are secured relative to tabs 214r, 214s and recesses 214t, 214u to assist in retaining arms 212a, 212b relative to holder 210 during use. In some embodiments, the method further comprises removing such arms and substituting different arms while retaining the same holder 210, drive system 240, and housing assembly 280.

In some embodiments, guides 288a, 288b guide movement of traveling adjuster 248a and/or central rod 242a during operation, and wheel stop 250a supports or aligns guides 288a, 288b to maintain a desired orientation of the guides. Accordingly, the method provides controlled and repeatable movement of arms 212a, 212b during opening and closing of crown holder 200.

In some embodiments, the method further comprises releasing the dental crown by rotating control wheel 246a to move arms 212a, 212b away from engagement with the dental crown. In some embodiments, the dental crown is released after placement, inspection, fitting, or other manipulation has been completed.

In some embodiments, any component or crown-engaging arrangement of crown holder 100 that is suitable for use with crown holder 200 may be used in the method. Thus, in one or more embodiments, the method comprises using crown holder 200 with crown-engaging arrangements corresponding to those of crown holder 100, including inside-gripping arrangements, outside-gripping arrangements, and looped outside-tip arrangements.

In some embodiments, FIGS. 15A and 15B illustrate a third arm and tip configuration of crown holder 200. In this configuration, arms 212a and 212b have distal tip ends 212c and 212d shaped to provide an outside-tip arrangement for engaging an outer surface of a dental crown. As shown in FIG. 15A, distal tip ends 212c and 212d are positioned closer together in a closed position. As shown in FIG. 15B, distal tip ends 212c and 212d are spaced farther apart in an open position.

In some embodiments, the third arm and tip configuration may be particularly suitable for engaging a dental crown from the outside, for example during positioning or placement of the dental crown. The shape of distal tip ends 212c and 212d may assist in contacting opposite outer portions of the crown while permitting visibility and access to the crown. Examples of looped outside tips and forked outside tips are shown in FIGS. 16C and 16D. In some embodiments, the third arm and tip configuration may provide an alternative to the arm and tip configurations shown in FIGS. 13A-14B while remaining operatively compatible with holder 210, arm seats 214a, 214b, drive system 240, control wheel 246a, traveling adjuster 248a, cover 286a, guides 288a, and wheel stop 250a.

As with other embodiments of crown holder 200, movement between the closed position of FIG. 15A and the open position of FIG. 15B is achieved through movement of traveling adjuster 248a and corresponding pivoting of arm seats 214a, 214b, thereby moving arms 212a, 212b relative to one another. In some embodiments, rotation of control wheel 246a actuates drive system 240, causing the arm and tip configuration of FIGS. 15A and 15B to move between positions for selective engagement and release of a dental crown.

In some embodiments, the third arm and tip configuration of FIGS. 15A and 15B may be removably mounted to holder 210 in the same general manner as other arm configurations described herein and may be selectively substituted for another arm pair to suit a particular clinical or laboratory procedure. FIGS. 16C and 16D further illustrate that crown holder 200 may be used with different outside-tip arrangements, including looped outside tips and forked outside tips.

### 5. Additional Crown-Engagement Configurations

In additional embodiments, the crown holder is configured so that the crown is held on the inside as illustrated in FIGS. 16A and 16B. In this arrangement, gripping portions engage an internal surface of the crown while the crown holder supports manipulation of the crown for handling, inspection, fitting, or similar procedures. A partially sectioned inside view is shown in FIG. 16B. In some embodiments, the gripping portions may include a forked arm tip that improves engagement, retention, and positioning of the crown while maintaining access and visibility.

The outside facets on the grips can be diamond coated, for example approximately D181 US Mesh 120/140, to grip the crown firmly on the inside of the dental crown.

In additional embodiments, the crown holder is configured so that the crown is held on the outside. This outside-holding arrangement may be used, for example, for placement of the crown. In further versions of the outside-holding arrangement, the outside tips may be configured as looped outside tips, as shown in FIG. 16C, or forked outside tips, as shown in FIG. 16D. The looped outside tips and forked outside tips may provide alternate crown-engaging structures for contacting and retaining the outer surface of the crown during placement or manipulation. The looped outside tips and forked outside tips may be substituted for, or used in place of, other outside-tip configurations.

### 6. Variations

This disclosure and the description of the invention is provided to assist in an understanding of various embodiments as defined by the claims and their equivalents. The embodiments are merely exemplary and various changes and modifications of the various embodiments may be made without departing from the scope and spirit of the invention. One or more embodiments may be combined with one or more other embodiments. Where one unit of an item is disclosed, more than one unit of that item may be used for at least the reason of economic efficiency. Conversely, where more than one unit of an item is disclosed, only one unit of that item may be used for at least the reason of economy, space-saving, manufacturing efficiency, and/or power consumption.

### LISTING OF ITEM NUMBERS

First embodiment
100—crown holder
102—distal end
104—proximal end
110—holder
112a, 112b—arms
112c, 112d—tip ends
112e, 112f—tapered curved outer surfaces
112g, 112h—planar surfaces
112i, 112j—abutments
112k, 112l—extensions
114a, 114b—arm seats
114c, 114d—wells
114e, 114f—upper portions
114g, 114h—curved surfaces
114i, 114j—lower portions
114k, 114m—proximal ends
114n, 114o—stops
114p, 114q—lower well segments
115a, 115b—through-openings
115c, 115d—ramps
116a, 116b—boots
117a, 117b—pins
140—drive system
142a—central rod
142b—distal end of central rod
142c—outer thread
142e—widened portion
142f—inner thread
142g—straight portion
144—travel thread
146a—control wheel
146b—outer surface
146d—opening
146e—floor
146f—internal thread
148a—traveling adjuster
148b—conical portion
148c—bearing ring
148d—bearing surface
148e—disk portion
148f—threaded end portion
180—housing assembly
182a—lower housing unit
182b—tubular body
182c—wall
182d—distal open end
182e—mating ring
182f—opening
184a—upper housing unit
184b—tubular body
184c—windows
184d—recess
184e—upper edge
184f—wall
184h—central opening portion
184i, 184j—openings
186a—lid
186b—disk segment portions
186d—block
186e—inner thread
186f, 186g—openings
186l, 186m—spaces
188—securing bolt
190—screws/fasteners

Second embodiment
200—crown holder
202—distal end
204—proximal end
210—holder
212a, 212b—arms
212c, 212d—tip ends
212e, 212f—tapered curved outer surfaces
212g, 212h—planar surfaces
212i, 212j—abutments
212k, 212l—extensions
212n—engagement plate
212m—retaining arm pairs
214a, 214b—arm seats
214c, 214d—wells
214e, 214f—upper portions
214g, 214h—curved surfaces
214i, 214j—lower portions
214k, 214l—lower segments
214r, 214s—tabs
214t, 214u—recesses
215a, 215b—through-openings
215c, 215d—slots
217a, 217b—pins
240—drive system
242a—central rod
242c—outer threaded portion
244—travel thread
246a—control wheel
246b—outer surface
246c—distal end of control wheel
246d—internal thread
248a—traveling adjuster
248b—body
248c—outer recesses
248d—through passage
248e—inner slot or recess
248f—lower portion
250a—wheel stop
250b—upstanding portion
250c—recesses
280—housing assembly
282a—lower housing unit
282b—tubular body
282c—wall
282d—distal open end
284a—upper housing unit
284b—tubular body
284c—windows
284d—recess
284e—upper edge
284f—circumferential wall
286a—cover or lid
286b, 286c—threaded openings
286e—recesses
286f—through hole
286g—passage
288a, 288b—guides
288c, 288d—threaded heads
288e, 288f—end portions

What is claimed is:

1. A crown holder, comprising:
a holder;
first and second arms supported by the holder, each of the first and second arms having a distal tip end configured to engage a dental crown;
first and second arm seats associated with the first and second arms, respectively;
a first pin extending through the first and second arm seats and defining a pivot axis about which the first and second arm seats are pivotable;
a second pin disposed in slots of the first and second arm seats; and
a drive system comprising a central rod, a control wheel, and a traveling adjuster,
wherein rotation of the control wheel causes movement of the traveling adjuster relative to the central rod, movement of the second pin within the slots of the first and second arm seats, pivoting of the first and second arm seats about the first pin, and corresponding movement of the distal tip ends of the first and second arms between an open position and a closed position.

2. The crown holder of claim 1, wherein the control wheel is supported in a fixed axial position relative to a housing of the crown holder while being rotatable relative thereto.

3. The crown holder of claim 1, wherein the central rod comprises a travel thread, and the control wheel comprises an internal thread cooperating with the travel thread.

4. The crown holder of claim 1, wherein the first and second arm seats comprise lower portions having through-openings receiving the first pin and angled slots receiving the second pin, the second pin being parallel to the first pin.

5. The crown holder of claim 1, wherein the traveling adjuster comprises a through passage receiving the second pin and a recess receiving lower portions of the first and second arm seats.

6. The crown holder of claim 1, further comprising first and second guides and a wheel stop, wherein the first and second guides guide movement of the traveling adjuster and the wheel stop supports or aligns the first and second guides.

7. The crown holder of claim 1, wherein the first and second arms are removably mounted to the first and second arm seats, respectively, by extensions of the first and second arms received in wells of the first and second arm seats in a friction fit.

8. The crown holder of claim 7, wherein additional retention of the first and second arms is provided by an engagement plate and retaining arm pairs configured to engage tabs formed on the first and second arm seats.

9. The crown holder of claim 1, wherein the first and second arms are splayed apart relative to each other along at least a portion of their length.

10. The crown holder of claim 1, wherein the distal tip ends are configured for selectively engaging the dental crown from an inside of the dental crown or from an outside of the dental crown, and wherein the distal tip ends comprise looped outside tips or friction-enhancing surfaces.

11. A method of using a crown holder, the method comprising:
providing a crown holder having a holder, first and second arms, first and second arm seats, a first pin, a second pin, a central rod, a control wheel, and a traveling adjuster;
rotating the control wheel to actuate a drive system of the crown holder;
moving the traveling adjuster relative to the central rod in response to rotation of the control wheel;
moving the second pin relative to slots of the first and second arm seats in response to movement of the traveling adjuster;
pivoting the first and second arm seats about the first pin in response to movement of the second pin; and
moving distal tip ends of the first and second arms relative to one another between an open position and a closed position to engage or release a dental crown.

12. The method of claim 11, wherein rotating the control wheel in a first direction moves the traveling adjuster in a distal direction and moves the distal tip ends outwardly relative to one another.

13. The method of claim 11, wherein rotating the control wheel in a second direction opposite the first direction moves the traveling adjuster in a proximal direction and moves the distal tip ends inwardly relative to one another.

14. The method of claim 11, further comprising engaging the dental crown from an inside of the dental crown with the distal tip ends.

15. The method of claim 11, further comprising engaging the dental crown from an outside of the dental crown with the distal tip ends.

16. The method of claim 15, wherein the distal tip ends comprise looped outside tips.

17. The method of claim 11, further comprising manipulating the crown holder after engaging the dental crown to inspect, transport, orient, fit, or place the dental crown relative to a prepared tooth.

18. The method of claim 11, wherein the first and second arms are removably mounted to the first and second arm seats, the method further comprising removing one pair of arms and installing another pair of arms having a different crown-engaging configuration.

19. The method of claim 11, wherein first and second guides guide movement of the traveling adjuster and a wheel stop supports or aligns the first and second guides during operation of the crown holder.

20. The method of claim 11, further comprising releasing the dental crown by rotating the control wheel to move the distal tip ends away from engagement with the dental crown.
